(19) United States
(12) Patent Application Publication
(10) Pub. No.: US 2010/0188455 A1
(43) Pub. Date: Jul. 29, 2010

(54) RECORDING APPARATUS AND METHOD OF CONTROLLING AIR RELEASING VALVE IN DRYING SECTION OF THE RECORDING APPARATUS

(75) Inventors: Osamu SHINKAWA, Chino-shi (JP); Keiji HARA, Minowa-machi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/691,897

(22) Filed: Jan. 22, 2010

(30) Foreign Application Priority Data
Jan. 26, 2009 (JP) 2009-013986

(51) Int. Cl. B41J 29/38; B41J 2/01

(52) U.S. Cl. 347/16; 347/102

(57) ABSTRACT

Provided is a recording apparatus comprising recording heads; a medium feeding unit; a position detecting unit; a drying section including an air generating unit and generates air, an air guiding portion, the drying section bringing the air guided by the air guiding portion into contact with the recording medium via an opening portion; a branching path which branches off over the range where the opening portion extends in the feeding direction, branches and guides part of the air flowing from the upstream side to the downstream side in the feeding direction in the air guiding portion of the drying section; an air releasing valve; and a control section which controls the opening or closing of the air releasing valve according to the position of the recording medium.

### BACKGROUND

1. Technical Field

The present invention relates to a recording apparatus including recording heads which execute recording by discharging ink onto a recording medium; a medium feeding unit which feeds the recording medium to a downstream side in the feeding direction; and a drying section including an air generating unit which is provided on the downstream side of the recording heads in the feeding direction and generates air, an air guiding portion which guides the air generated by the air generating unit from the upstream side to the downstream side in the feeding direction and forms a flow passage, and an opening portion which extends in the feeding direction in the middle of the flow passage in the air guiding portion so as to face the recording medium, the drying section bringing the air guided by the air guiding portion into contact with the recording medium via the opening portion and drying ink on the recording medium, and a method of controlling the drying section in the recording apparatus. In the present application, the recording apparatus includes such machines as an ink jet printer, a wire dot printer, a laser printer, a line printer, a copying machine, a facsimile, and the like.

2. Related Art

In the related art, according to JP-A-2002-292841, the recording apparatus includes recording heads and a drying unit. Among these, the recording heads were provided so as to execute recording by discharging ink onto a sheet which is an example of a recording medium. Furthermore, the drying unit was provided so as to blow hot air onto the recorded sheet. Thus, the drying of ink on the recorded sheet can be prompted.

However, the amount of the hot air blown onto the sheet was always constant. Moreover, when the hot air which includes factors spanning from an upstream side to a downstream side in a sheet feeding direction is blown onto a sheet, in other words, if the hot air is obliquely blown onto the surface of the sheet from the tailing end side to the leading end side of the sheet, there is problem that the hot air may go into the gap between the tailing end of the sheet and a supporting portion which supports the sheet when the tailing end of the sheet passes through the drying unit. In this case, there is a problem in that the tailing end of the sheet flutters because the tailing end is separated from the supporting portion and receives the hot air. In addition, the fluttering causes the problem of so called paper jamming.

### SUMMARY

An advantage of some aspects of the invention is that it provides a recording apparatus which reduces fluttering of the tailing end of a recording medium in a feeding direction caused by air when drying ink on the recording medium with the air generated therein, and a method of controlling a drying section in the recording apparatus.

According to a first aspect of the invention, the recording apparatus includes recording heads that execute recording by discharging ink onto a recording medium; a medium feeding unit that feeds the recording medium to a downstream side in a feeding direction; a position detecting unit that detects the position of the recording medium in the feeding direction; a drying section including an air generating unit that is provided on the downstream side of the recording heads in the feeding direction and generates air, an air guiding portion that guides the air generated by the air generating unit from the upstream side to the downstream side in the feeding direction and forms a flow passage, and an opening portion which extends in the feeding direction in the middle of the flow passage of the air guiding portion so as to face the recording medium, the drying section bringing the air guided by the air guiding portion into contact with the recording medium via the opening portion so as to dry the ink on the recording medium; a branching path which branches off over the range where the opening portion extends in the feeding direction, branches and guides part of the air flowing from the upstream side to the downstream side in the feeding direction in the air guiding portion of the drying section; an air releasing valve which is provided on the branching path and is opened or closed; and a control section which controls the opening or closing of the air releasing valve according to the position of the recording medium.

According to the above-described aspect, the recording apparatus is provided with the branching path, the air releasing valve, and the control section. Accordingly, it is possible to reduce the flow amount and rate of the air that comes into contact with a recording medium by switching the state of the air releasing valve from a closed state to an opened state. In other words, it is possible to adjust the flow amount and rate of the air that comes into contact with the recording medium in the downstream side of a branching point on which the branching path branches off from the air guiding portion in the feeding direction without changing the output of the air generating unit. As a result, it is possible to reduce the problem of the tailing end of the recording medium fluttering.

For example, the control section controls the air releasing valve to be in an opened state from when the tailing end of the recording medium passes the branching point of the branching path to when the tailing end of the recording medium passes the downstream end of the opening portion in the feeding direction. In this case, it is possible to branch off part of the air to the branching path. Accordingly, it is possible to reduce the flow amount of the air that comes into contact with the tailing end of the recording medium via the opening portion. In addition, it is possible to lower the flow rate of the air that comes into contact with the tailing end of the recording medium via the opening portion by branching off part of the air. As a result, it is possible to reduce the problem of the tailing end of the recording medium fluttering. In other words, it is possible to lessen the problem that the tailing end of the recording medium flaps.

As a second aspect of the invention according to the above-described aspect, in the case where the recording medium passes through the drying section, the control section closes the air releasing valve until the tailing end of the recording medium reaches the position of a branching point on which the branching path branches off from the air guiding portion in the feeding direction. Furthermore, the control section opens the air releasing valve when the tailing end of the recording medium reaches the position of the branching point in the feeding direction, and the control section closes the air releasing valve when the tailing end of the recording medium reaches the position of the downstream end of the opening portion in the feeding direction.

Here, the “branching point” refers to a spot where a path is divided. Precisely, it refers to a spot where a path starts to be divided.

According to the second aspect of the invention, in addition to the same action and effect as in the first aspect, part of the air can be branched off to the branching path when the tailing end of the recording medium reaches the position of the branching point in the feeding direction as described above. Accordingly, it is possible to reduce the flow amount of the air that comes into contact with the tailing end of the recording medium via the opening portion. Furthermore, it is possible to lower the flow rate of the air that comes into contact with the tailing end of the recording medium via the opening portion by branching off part of the air.

Moreover, the air releasing valve is configured to be closed when the tailing end of the recording medium reaches the position of the downstream end of the opening portion in the feeding direction. Accordingly, it is possible to dry ink on the recording medium by returning the level of the flow amount and flow rate of the air that comes into contact with the leading end side of the succeeding recording medium back to the initial level. In other words, it is possible to maintain the drying efficiency for the leading end side of the recording medium such that there is no problem of it fluttering due to increasing the flow amount and flow rate of the air.

As a third aspect of the invention according to the first aspect, the air guiding portion in the drying section has an air flow passage of which the sectional areas gradually decreases as the air advances from the upstream side to the downstream side in the flowing direction within the range where the opening portion extends in the feeding direction.

According to the above-described aspect, in addition to the same action and effect as in the first aspect, it is possible to raise the flow rate of the air in the downstream side so as to be higher than the flow rate in the upstream side by lowering the flow rate of the air in the upstream side in the flowing direction.

Accordingly it is possible to increase the viscosity of the ink on the recording medium by bringing the slow-flowing air in the upstream side in the feeding direction into contact with the recording medium. In other words, it is possible to reduce the problem that half-dried ink is disturbed by the air.

Then, it is possible to dry the ink completely by bringing fast-flowing air into contact with the high-viscosity ink on the recording medium in the downstream side in the feeding direction.

Furthermore, when the flow rate of the air that comes into contact with the recording medium gets higher as it advances in the downstream side in the feeding direction, the problem is raised that the tailing end of the recording medium flutters. In this case, the branching path and the air releasing valve are particularly useful.

With the above-described configuration of sectional areas, it is possible to make the flow rate of the air that comes into contact with the recording medium in the upstream side of the branching point in the feeding direction lower than the flow rate of the air in the downstream side in a state where the air releasing valve is closed. Therefore, it is possible to eliminate the problem of the tailing end of the recording medium fluttering in the upstream side of the branching point.

As a fourth aspect of the invention according to the first aspect, a plurality of the branching paths having the air releasing valves is provided, and a plurality of the branching points is arranged in series in the feeding direction, on which the branching paths branch off from the air guiding portion. With respect to the air releasing valves other than the air releasing valve corresponding to the furthest downstream branching point in the feeding direction among the plurality of the air releasing valves, when the tailing end of the recording medium reaches the position of one branching point in the feeding direction, the control section opens the air releasing valve corresponding to the one branching point, and when the tailing end of the recording medium reaches the position of another branching point adjacent to the downstream side of one branching point in the feeding direction, the control section opens the air releasing valve corresponding to the another branching point and closes the air releasing valve corresponding to the one branching point. With respect to the air releasing valve corresponding to the furthest downstream branching point in the feeding direction among the plurality of the air releasing valves, when the tailing end of the recording medium reaches the position of the furthest downstream branching point in the feeding direction, the control section opens the air releasing valve corresponding to the furthest downstream branching point in the feeding direction, and when the tailing end of the recording medium reaches the position of the downstream end of the opening porting in the feeding direction, the control section closes the air releasing valve corresponding to the furthest downstream branching point in the feeding direction.

According to the fourth aspect of the invention, in addition to the same action and effect as in the first aspect, the control section opens air releasing valve corresponding to the branching point from among the plurality of the air releasing valves according to the position of the tailing end of the recording medium. Accordingly, it is possible to lower the flow rate of the air that comes into contact with the tailing end of the recording medium. Specifically, it is useful when the opening portion of the drying section is long in the feeding direction.

As a fifth aspect of the invention according to the first aspect, when the number of branching paths is one, the distance between the tailing end of the preceding recording medium and the leading end of the succeeding recording medium is equal to the distance from the branching point of the branching path in the feeding direction to the downstream end of the opening portion in the feeding direction. When the number of branching paths is more than one, the distance between the tailing end of the preceding recording medium and the leading end of the succeeding recording medium is equal to the distance from the furthest downstream branching point in the feeding direction to the downstream end of the opening portion in the feeding direction.

Here, the “equal” preferably refers to “substantially the same,” and allows a slight variance in the position of the recording medium.

According to the fifth aspect of the invention, in addition to the same action and effect as in the first aspect, there is no problem due to the change in the flow amount of the air for the tailing end of the preceding recording medium affects the succeeding recording medium. In other words, there is no problem due to a fall in the drying efficiency of the ink affecting the succeeding recording medium even when the air releasing valve is opened or closed in order to adjust the flow amount of the air for the tailing end of the preceding recording medium.

As a sixth aspect of the invention, a method of controlling an air releasing valve in a drying section of a recording apparatus includes feeding a recording medium to a downstream side in a feeding direction by a medium feeding unit; recording by discharging ink onto the recording medium from recording heads; detecting a position of the recording medium in the feeding direction by a position detecting unit; drying ink on the recording medium using the drying section by bringing the air guided by the air guiding portion into contact with the recording medium via an opening portion, the drying section including an air generating unit that is provided on the downstream side of the recording heads in the feeding direction and generates air, an air guiding portion that guides the air generated by the air generating unit from the upstream side to the downstream side in the feeding direction and forms a flow passage, and an opening portion that extends in the feeding direction in the middle of the flow passage of the air guiding portion so as to face the recording medium; opening an air releasing valve provided on a branching path when the tailing end of a recording medium in the feeding direction reaches a position of the branching point where the branching path, which branches off over the range where the opening portion extends in the feeding direction, branches and guides part of the air flowing from the upstream side to the downstream side in the feeding direction in the air guiding portion of the drying section, branches off from the air guiding portion; and closing the air releasing valve when the tailing end of the recording medium reaches the position of the downstream end of the opening portion in the feeding direction after the opening of the air releasing valve.

According to the sixth aspect of the invention, it is possible to obtain the same action and effect as in the second aspect.

As a seventh aspect of the invention, a method of controlling an air releasing valve in a drying section of a recording apparatus includes feeding a recording medium to a downstream side in a feeding direction by a medium feeding unit; recording by discharging ink onto the recording medium from recording heads; detecting a position of the recording medium in the feeding direction by a position detecting unit; drying ink on the recording medium using a drying section by bringing the air guided by the air guiding portion into contact with the recording medium via an opening portion, the drying section including an air generating unit that is provided on the downstream side of the recording heads in the feeding direction and generates air, an air guiding portion that guides the air generated by the air generating unit from the upstream side to the downstream side in the feeding direction and forms a flow passage, and an opening portion that extends in the feeding direction in the middle of the flow passage of the air guiding portion so as to face the recording medium; with respect to a plurality of air releasing valves that are arranged in series in this order in the feeding direction, branches off over the range where the opening portion extends in the feeding direction and provided on a plurality of branching paths that branches and guides part of the air flowing from the upstream side to the downstream side in the feeding direction in the air guiding portion of the drying section, opening an air releasing valve corresponding to one branching point when the tailing end of the recording medium reaches the position of the one branching point in the feeding direction, with respect to the air releasing valves other than the air releasing valve corresponding to the furthest downstream branching point in the feeding direction among a plurality of branching points on which the plurality of the branching paths branches off from the air guiding portion among the plurality of the air releasing valves, and opening the air releasing valve corresponding to the furthest downstream branching point in the feeding direction when the tailing end of the recording medium reaches the position of the furthest downstream branching point in the feeding direction, with respect to the air releasing valve corresponding to the furthest downstream branching point in the feeding direction among the plurality of the air releasing valves; and closing an air releasing valve corresponding to one branching point when the tailing end of the recording medium reaches a position of another branching point adjacent to the downstream side of the one branching point in the feeding direction, with respect to the air releasing valves other than the air releasing valve corresponding to the furthest downstream branching point in the feeding direction among the plurality of the air releasing valves, and closing the air releasing valve corresponding to the furthest downstream branching point in the feeding direction when the tailing end of the recording medium reaches the position of the downstream end of the opening portion in the feeding direction, with respect to the air releasing valve corresponding to furthest downstream the branching point in the feeding direction among the plurality of the air releasing valves.

According to the above aspect, it is possible to obtain the same action and effect as in the fourth aspect.

### BRIEF DESCRIPTION OF THE DRAWINGS

FIG. 1 is a side view schematically illustrating the whole of a printer according to the invention.

FIG. 2 is a top view schematically illustrating the whole of the printer according to the invention.

FIG. 3 is a side view schematically illustrating the operation of a hot air unit according to the invention.

FIG. 4 is a side view schematically illustrating the operation of the hot air unit according to the invention.

FIG. 5 is a side view schematically illustrating the operation of the hot air unit according to the invention.

FIG. 6 is a flowchart showing the control of an air-opening valve in the hot air unit according to the invention.

FIG. 7 is a side view schematically illustrating a hot air unit according to the other embodiment 1.

FIG. 8 is a side view schematically illustrating the operation of the hot air unit according to the other embodiment 2.

FIG. 9 is a side view schematically illustrating the operation of the hot air unit according to the other embodiment 2.

FIG. 10 is a side view schematically illustrating the operation of the hot air unit according to the other embodiment 2.

FIG. 11 is a side view schematically illustrating the operation of the hot air unit according to the other embodiment 2.

FIG. 12 is a side view schematically illustrating the operation of the hot air unit according to the other embodiment 2.

### DESCRIPTION OF EXEMPLARY EMBODIMENTS

Hereinafter, exemplary embodiments of the invention will be explained with reference to accompanying drawings.

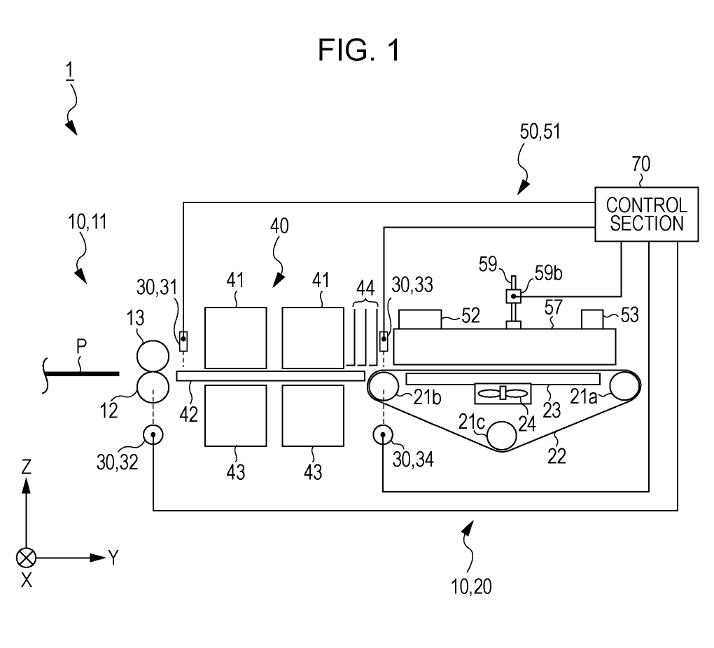

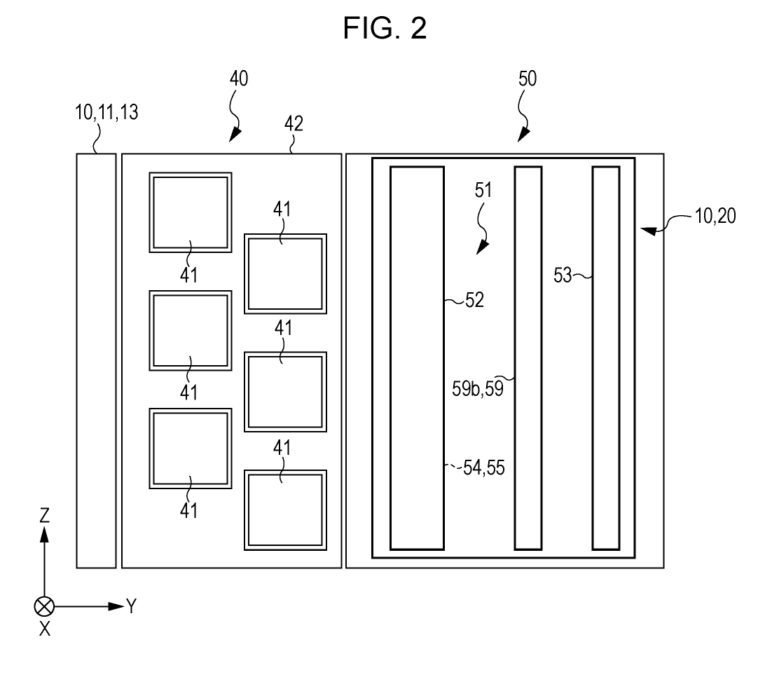

FIG. 1 is a side view schematically illustrating the whole of an ink jet printer 1 (hereinafter referred to as “printer”) as an example of a “recording apparatus” or “liquid ejecting apparatus” according to the invention. FIG. 2 is a top view schematically illustrating the whole of the printer according to the invention.

Here, the liquid ejecting apparatus is not limited to recording apparatuses such as an ink jet type recording apparatus, a copying machine and a facsimile which execute recording on a recording member, such as a recording sheet, by ejecting ink from recording heads as liquid ejecting heads onto the member. The liquid ejecting apparatus also includes an apparatus which ejects instead of ink a liquid for a specific application from liquid ejecting heads corresponding to the above-described recording heads onto a member to be ejected onto which corresponds to a member to be recorded, so as to make the liquid adhere to the member to be ejected onto.

Furthermore, in addition to the above-described recording heads, the examples of the liquid ejecting heads include a coloring material ejecting head used in manufacturing a color filter of a liquid crystal display or the like, an electrode material (conductive paste) ejecting head used in forming an electrode of an organic EL display, a field emission display (FED) or the like, a bio-organic ejecting head used in manufacturing a bio-chip, and a sample ejecting head ejecting a sample as a precision pipette.

As shown in FIG. 1 and FIG. 2, the printer 1 is provided with a transport unit 10, a recording section 40, a drying section 50, a position detecting unit 30, and a control section 70. Among these, the transport unit 10 is configured to transport a sheet P to a downstream side in a feeding direction as a medium feeding process. Specifically, the transport unit 10 includes a pair of feeding rollers 11 provided on the upstream side of the recording section 40 and a suction belt mechanism 20 provided on the downstream side of the recording section 40 in the feeding direction Y.

The pair of the feeding rollers 11 includes a driving feeding roller 12 and a driven feeding roller 13. Among these, the driving feeding roller 12 is configured to be driven by the force of a first transport motor (not shown in the drawing). On the other hand, the driven feeding roller 13 is configured to be rotated in accordance with the rotation of the driving feeding roller 12. The driving feeding roller 12 and the driven feeding roller 13 are configured to transport the sheet P to the downstream side in the feeding direction in tandem with each other.

The suction belt mechanism 20 is provided with three rollers 21a, 21b, and 21c, a belt 22 which have a plurality of holes and are wound on the three rollers 21a, 21b, and 21c, and a suction unit 24 which sucks air via the plurality of holes. A suction fan may be used as the suction unit 24. The driving of the roller 21a in the downstream side in the feeding direction by the force of a second transport motor (not shown) causes the belt 22 to be driven and feed the sheet P. A drying-time medium supporter 23 provided on the upper side of the suction belt mechanism 20 is configured to support the back side of the sheet P with the belt 22 interposed therebetween.

The suction unit 24 is configured to suck air above the drying-time medium supporter 23 downwardly via the plurality of holes in the belt 22.

Furthermore, the suction unit is configured to suck the air in the entire region of the drying-time medium supporter 23.

Accordingly, the suction unit 24 can firmly attach the sheet P on the drying-time medium supporter 23 thereto with the belt 22 interposed therebetween. As a result, the sheet P can be fed to the downstream side in the feeding direction with high precision by the driving of the belt 22. In addition, the sheet P can be retained when hot air is blown onto the sheet P by the drying section 50 to be described later.

The recording section 40 is configured to execute recording by discharging ink onto the surface of the sheet P fed by the pair of the feeding rollers 11 in a recording process. Specifically, the recording section 40 is provided with a recording-time medium supporter 42, a plurality of recording heads 41, a plurality of caps 43, and a windshield plate 44. Among these, the recording-time medium supporter 42 is configured to support the back side of the sheet P.

The plurality of the recording heads 41 is provided above the recording-time medium supporter 42 so as to move in the width direction X of the sheet P. Specifically, the heads are provided so as to move between a recording position which faces the recording-time medium supporter 42 and a waiting position which does not face the recording-time medium supporter 42 by the driving of a motor for moving heads (not shown) while being guided by a first guiding portion (not shown).

The plurality of the caps 43 is provided in a position facing the plurality of the recording heads 41 in a waiting position so as to move in the facing direction Z. Specifically, the caps are provided so as to move between a sealing position which seals nozzle faces of the plurality of the recording heads 41 in the waiting position and a retreating position which does not seal the nozzle faces by the force of a motor for moving caps (not shown) while being guided by a second guiding portion (not shown).

The windshield plate 44 is provided on the downstream side in the feeding direction of the plurality of the recording heads 41 in the recording position. Furthermore, the windshield plate 44 is configured to reduce the advance of air generated in the drying section 50 which will be described later to the recording section 40. In addition, the windshield plate 44 is configured to reduce the conduction of heat generated in the drying section 50 to the recording section 40.

It is preferable that the windshield plate 44 be formed of a heat-insulating material which reduces the conduction of heat. In addition, it is preferable that a plurality of windshield plate 44 be provided with slight gaps between one another.

The recording heads 41 are configured to execute recording by discharging ink onto the surface of the sheet P.

The drying section 50 is configured to dry ink on the recorded sheet P as a drying process. The drying section 50 includes a convection type hot air unit 51 which blows hot air onto the sheet P and the drying-time medium supporter 23 described above.

Here, the “convection type” refers to a method of transmitting heat by fluid such as gas or liquid.

The hot air unit 51 includes an air inlet 52, an air outlet 53, and an air-opening valve 59b, which will be described later in detail.

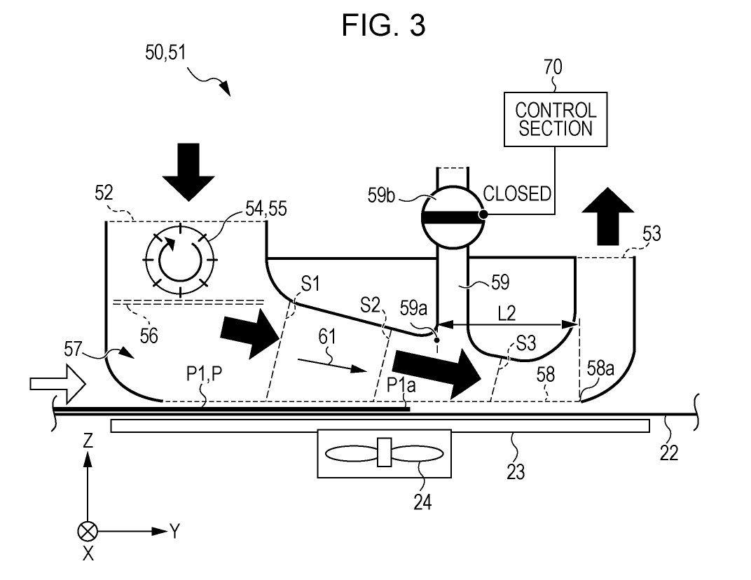

Among these, the air inlet 52 is provided so as to bring air into the hot air unit 51. Furthermore, the air outlet 53 is provided so as to release the air in the hot air unit 51 to the outside. The air-opening valve 59b is provided on a branching path 59 which branches off from an air guiding portion 57 guiding air from the air inlet 52 to the air outlet 53 (see FIG. 3 to FIG. 5). In addition, the air-opening valve 59b is configured to be opened or closed by the control section 70.

The position detecting unit 30 is configured to detect a position of the sheet P in the feeding direction Y as a position detecting process. Specifically, the position detecting unit 30 includes a first sheet detecting sensor 31 and a second sheet detecting sensor 33.

Here, the first sheet detecting sensor 31 and the second sheet detecting sensor 33 may be any one of a non-contact type optical sensor or a contact type mechanical sensor. Any sensor may be used if the sensor detects the leading end or the tailing end of the sheet P so that the control section 70 can determine the leading end or the tailing end of the sheet P.

A first encoder 32 is provided in the driving feeding roller 12. Accordingly, the control section 70 can determine the driving amount of the driving feeding roller 12. The first sheet detecting sensor 31 is provided in the vicinity of the driving feeding roller 12. As a result, the sheet P can be fed with high precision. Specifically, recording is started when the sheet P is fed a predetermined distance toward the downstream side after the first sheet detecting sensor 31 detects the leading end of the sheet P.

A second encoder 34 is provided in the roller 21b in the upstream side. Accordingly, the control section 70 can determine the driving amount of the suction belt mechanism 20. The second sheet detecting sensor 33 is provided in the vicinity of the roller 21b in the upstream side. As a result, the sheet P can be fed in the drying section 50 after recording with high precision. Furthermore, the opening and closing of the air-opening valve 59b can be switched with high precision in accordance with the position of the tailing end of the sheet P as will be described below.

The sheet P dried by the drying section 50 is fed to the downstream side so as to be discharge to a discharging section (not shown).

Next, the hot air unit 51 of the drying section 50 will be described in detail.

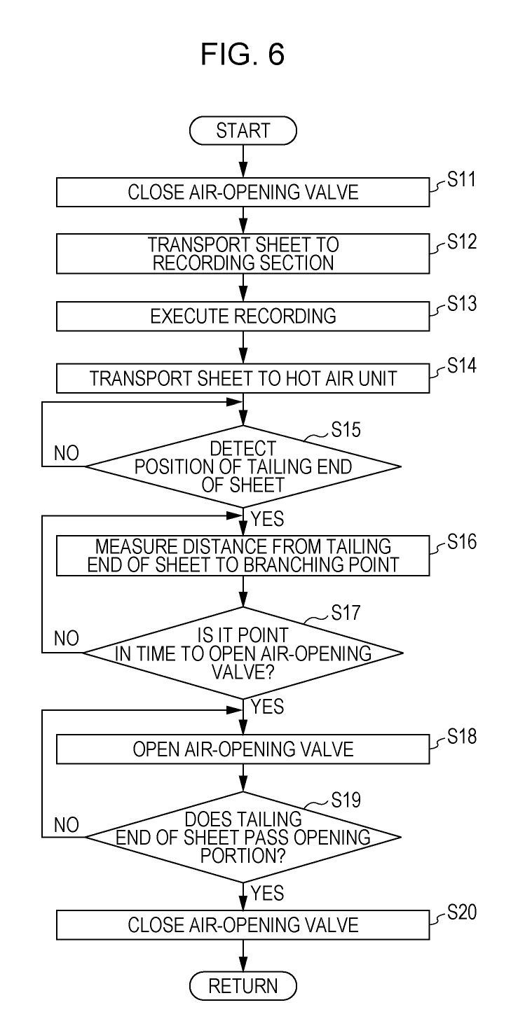

FIG. 3 to FIG. 5 are side views schematically illustrating the operation of the hot air unit according to the invention. FIG. 6 is a flowchart showing the control of the air-opening valve in the hot air unit according to the invention.

As shown in FIG. 3 to FIG. 5, the hot air unit 51 of the drying section 50 in the invention is provided with an air inlet 52, an air outlet 53, an air generating unit 54, a heater 56, an air guiding portion 57, an opening portion 58, a branching path 59 and an air-opening valve 59b.

Among these, the air inlet 52 is configured to bring air into the hot air unit as described above. The air outlet 53 is configured to release the air in the hot air unit to the outside as described above.

Here, the air inlet 52 is provided on the upstream side in the feeding direction, which is upward in the direction of the axis Z of the hot air unit 51. On the other hand, the air outlet 53 is provided on the downstream side in the feeding direction, which is upward in the direction of the axis Z of the hot air unit 51.

The air generating unit 54 is configured to generate air to flow from the air inlet 52 to the air outlet 53. In other words, the air generating unit generates air to flow from the upstream side to the downstream side in the feeding direction within the hot air unit. Specifically, an example of the air generating unit 54 is a blowing fan 55, which is so called a cross flow fan.

The “cross flow fan” is a fan of which the diameter is relatively short and the length is transversely long. The cross flow fan blows air drawn from one of the impellers in the radial direction to the opposite impeller side in the radial direction. The fan is also referred to as a transverse fan.

The blowing fan 55, which is a cross flow fan, extends in the width direction X and matches with the shape of the air inlet 52 which is long in the width direction X.

The heater 56 is configured to heat the air blown by the blowing fan 55. Accordingly, the air can be hot air. The heater 56 may be formed of a nichrome wire or the like, for example. The nichrome wire can generate heat by itself due to electric conduction and heat the nearby air.

The air guiding portion 57 is configured to guide the air generated by the blowing fan 55 from the air inlet 52 to the air outlet 53 within the hot air unit.

The opening portion 58 extends in the feeding direction Y so as to face the sheet P below the direction of axis Z in the air guiding portion 57. Specifically, the air flowing in the air guiding portion 57 from the upstream side to the downstream side in the feeding direction is blown onto the sheet P via the opening portion 58. As shown in FIG. 3 to FIG. 5, the opening portion 58 is provided in the vicinity of the drying-time medium supporter 23 and faces therewith.

The branching path 59 branches off over the range where the opening portion 58 extends in the feeding direction Y in the air guiding portion 57. In addition, the branching path is provided so as to branch and guide part of the air in the air guiding portion 57. In other words, if a flow passage 61 guided by the air guiding portion 57 from the air inlet 52 to the air outlet 53 is assumed to be the main line, part of the air is branched off and guided from the main line. Here, a branching point 59a where the main line branches off is within the range where the opening portion 58 extends in the feeding direction Y.

The air-opening valve 59b is provided on the branching path 59 so as to be switched to be opened and closed by the control section 70. As an example of the air-opening valve 59b, a so-called electromagnetic valve which is a solenoid valve can be used.

The air-opening valve 59b is formed to be long in the width direction X in accordance with the shape of the section of the branching path 59 (see FIG. 2).

When the air-opening valve 59b is opened, part of the air guided to the branching path 59 is discharged from the hot air unit 51. On the other hand, when the air-opening valve 59b is closed, part of the air guided in the branching path 59 stops flowing.

As a result, the flow amount and flow rate of the air in the downstream side in the air flowing direction of the branching point 59a in the main line of the flow passage 61 may be changed.

Specifically, by opening the air-opening valve 59b, part of the air flowing to the downstream side in the air flowing direction of the branching point 59a in the main line of the flow passage 61 flows toward the branching path 59 and is discharged. Accordingly, the amount of the air flowing to the downstream side in the air flowing direction of the branching point 59a in the main line of the flow passage 61 can be reduced by that much. The flow rate of the air is lower than the flow rate when the air-opening valve 59b is closed depending on the decrease of the air amount.

The sectional areas of the flow passage 61 in the air guiding portion 57 become gradually smaller as the air advances to the downstream side in the air flowing direction in the range where the opening portion 58 extends in the feeding direction Y (see FIG. 3).

Here, when it is assumed that there are a first position, a second position, and a third position in the downstream side of the branching point 59a from the upstream side in the air flowing direction in this order, the following relationship is established;

Sectional area S1 of the first position>Sectional area S2 of the second position>Sectional area S3 of the third position.

Due to the relationship above, the flow amount and flow rate of the air can be gradually raised as the air advances to the downstream side in the air flowing direction. Accordingly, the hot air, which is relatively slowly flowing to the upstream side in the feeding direction, comes into contact with the surface of the sheet P in the range where the opening portion 58 extends, and evaporates moisture in ink thereon so as to increase the viscosity of the ink. In addition, as the viscosity of the ink on the surface of the sheet P fed to the downstream side increases gradually, the blown hot air becomes gradually intensified and evaporates organic solvents in the ink components.

Here, it is assumed that the boiling point of the organic solvents in the ink components is higher than that of moisture.

As a result, it is possible to dry the ink tidily with no problem of the wet ink being disturbed by the air. In other words, ink can be dried completely and efficiently by having hot air blowing slowly from the upstream side so as to come into contact with the ink on a sheet so as to increase the viscosity, and having the hot air to strongly come into contact with the ink again gradually as the air moves to the downstream side.

Next, the action and effect of the branching path 59 and the air-opening valve 59b will be explained.

As shown in FIG. 3, the sheet P1 (P) is fed to the drying section 50 from the recording section 40. At this point, the air-opening valve 59b is in a closed state. In addition, the leading end side of the sheet P1 is gradually fed to the downstream side in the feeding direction, and faces the opening portion 58. At this point, the leading end side of the sheet P1 is positioned in the upstream side in the range where the opening portion 58 extends. Accordingly, as described above, the relatively slow hot air comes into contact with the leading end side of the sheet P1. Also, the moisture in the ink components on the leading end side of the sheet P1 is evaporated so as to increase the viscosity of the ink.

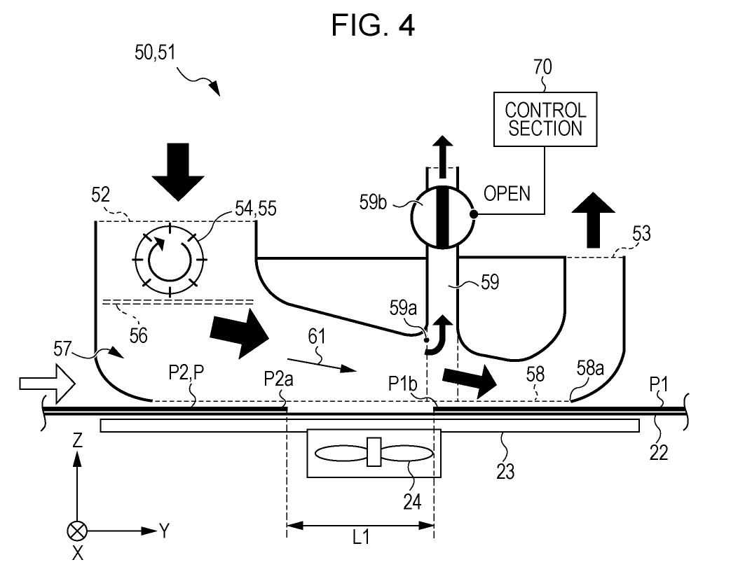

As shown in FIG. 4, the sheet P1 in the state shown in FIG. 3 is fed to the downstream side in the feeding direction. When the leading end of the sheet P1 passes the branching point 59a and reaches the third position (S3 (see FIG. 3)), the hot air blows strongly. At this point, the viscosity of the ink has already increased, and thus there is no problem of the ink being disturbed by the air even when the air strongly blows. Moreover, the hot air that blows strongly makes it possible to dry the ink completely.

When the sheet P1 is fed to the downstream side in the feeding direction and the tailing end P1b of the sheet P1 reaches the position of the branching point 59a in the feeding direction Y, the control section 70 opens the air-opening valve 59b. Accordingly, it is possible to reduce the flow amount and flow rate of the hot air in the vicinity of the first position in the upstream side of the branching point 59a. As a result, it is possible to reduce the problem that the tailing end P1b of the sheet P1 flutters due to the hot air passing the third position (S3 (see FIG. 3)) of the main line in the flow passage 61 when the sheet P1 is further fed to the downstream side in the feeding direction, and the tailing end P1b of the sheet P1 is positioned between the branching point 59a and the downstream end 58a of the opening portion 58 in the feeding direction Y.

With simple explanation, at this point, the force that the hot air goes into the gap between the tailing end Plb of the sheet P1 and the belt 22 can be set to be weaker than the suction force of the suction unit 24 of the suction belt mechanism 20.

As a result, there is no problem that the hot air flutters the tailing end P1b of the sheet P1. In addition, there is no problem that the surface of the sheet P1 is damaged. Also, there is no problem of paper jamming.

In this case, the leading end P2a of the sheet P2 succeeding the preceding sheet P1 is positioned in the upstream side within the range where the opening portion 58 extends. Relatively slow hot air comes into contact with the leading end side of the succeeding sheet P2 as it does with the leading end Pla of the preceding sheet P1. Then, the moisture in the ink components on the leading end side of the succeeding sheet P2 is evaporated so as to increase the viscosity of the ink. At this point, the succeeding sheet P2 is positioned in the upstream side of the branching point 59a in the feeding direction Y.

Accordingly, there is no influence from the opening of the air-opening valve 59b. In other words, there is no problem in that the drying efficiency is lowered.

As in the later description, the distance L1 from the tailing end P1b of the preceding sheet P1 to the leading end of the succeeding sheet is equal to the distance L2 (see FIG. 3) from the branching point 59a in the feeding direction Y to the downstream end 58a of the opening portion 58 in the feeding direction.

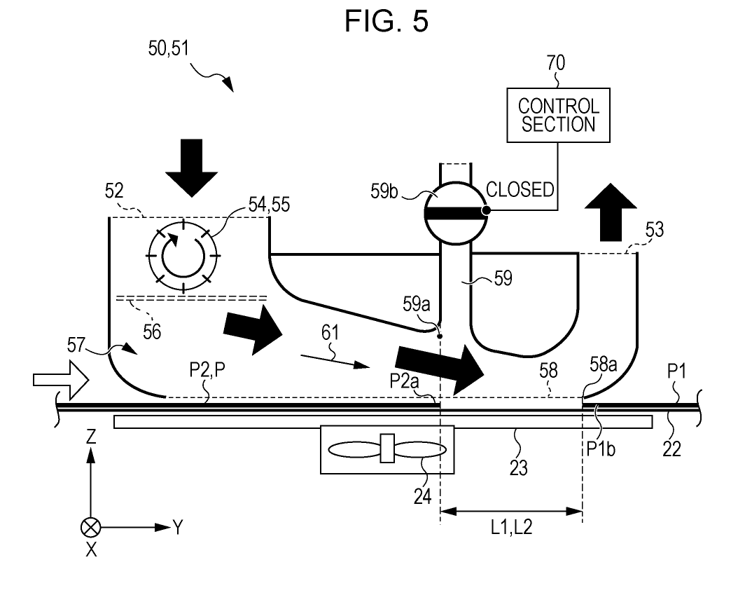

As shown in FIG. 5, the sheet in the state shown in FIG. 4 is fed further to the downstream side in the feeding direction. When the tailing end P1b of the preceding sheet P1 reaches the position of the downstream end 58a of the opening portion 58 in the feeding direction Y, the control section 70 closes the air-opening valve 59b. At this point, the leading end P2a of the succeeding sheet P2 timely reaches the position of the branching point 59a in the feeding direction Y. In other words, the distance L1 from the tailing end P1b of the preceding sheet P1 to the leading end of the succeeding sheet is equal to the distance L2 from the branching point 59a in the feeding direction Y to the downstream end 58a of the opening portion 58 in the feeding direction.

Accordingly, when the leading end side of the succeeding sheet P2 passes the branching point 59a in the feeding direction Y, the hot air strongly comes into contact with the leading end side of the succeeding sheet P2. As a result, the ink can be dried completely as in the leading end side of the preceding sheet P1. Furthermore, when the tailing end P2b of the succeeding sheet P2 reaches the position of the branching point 59a in the feeding direction Y, the control section 70 opens the air-opening valve 59b. Accordingly, as described above, it is possible to reduce the flow amount and flow rate of the hot air in the vicinity of the first position (S1 (see FIG. 3)) in the upstream side of the branching point 59a. As a result, there is no problem that the hot air flutters the tailing end P2b of the succeeding sheet P2 or the tailing end P1b of the preceding sheet P1.

In the present embodiment, the number of branching points 59a is one and the position where the branching point 59a is provided on the feeding direction Y is decided based on the relationship between the force of the air, which goes into the gap between the tailing end P1b of the sheet P1 and the belt 22 to separate the sheet P1 from the belt 22, and the suction force of the suction unit 24 in the suction belt mechanism 20. The sectional areas of the flow passage 61 (S1 and S2) are relatively large and the air can move slowly in the upstream side of the branching point 59a. Therefore, there is no problem that the hot air flutters the tailing end P1b of the sheet P1.

On the other hand, there is a precondition that the sectional area (S3) of the flow passage 61 is relatively small and the air is strong enough such that the hot air flutters the tailing end P1b of the sheet P1 in the downstream side of the branching point 59a.

When the force of the air from the blowing fan 55 is relatively weak, the suction unit 24 in the suction belt mechanism 20 is not always necessary. Only a pair of rollers such as the pair of the feeding rollers may transport the sheet. In other words, the hot air unit in the present embodiment may be combined with a configuration where only the pair of the rollers transports the sheet. In this case, it is needless to say that the relationship between the tension or weight of the sheet and the force of the hot air which goes into the back side of the sheet and separates the sheet from the supporter which supports the sheet determines the position of the branching point 59a.

In other words, it is needless to say that the position of the branching point 59a in the feeding direction Y is determined based on the relationship between the force with which the tailing end P1b of the sheet P1 keeps its positioning at the position in the direction of axis Z (such as suction force of the suction unit in the suction belt mechanism, the tension and weight of the sheet, and the like) and the force with which the air generating unit 54 (55) separates the tailing end P1b of the sheet P1 from the supporters (22 and 23) which support the sheet P1, and the shape of the air guiding portion 57.

Next, the operation above will be explained focusing on the control section 70.

As shown in FIG. 6, in Step 11 (hereinafter, simply S11), the control section 70 closes the air-opening valve 59b. At this point, when the valve has already been closed, the state is maintained. In additions, the process proceeds to S12 in order to start transporting.

In S12, the sheet P1 is transported as a medium feeding process. Specifically, the control section 70 drives the pair of the feeding rollers 11 as transport unit 10 and feeds the sheet P1 to the downstream side in the feeding direction. Then, the process proceeds to S13 in order to start recording.

Furthermore, it is assumed that the pair of the feeding rollers 11 continues transporting the sheet P1 even after the process proceeds to S13 and thereafter.

In S13, recording is executed as a recording process. Specifically, the control section 70 transmits a signal to the recording heads 41 of the recording section 40 to control the recording heads 41 so as to discharge ink onto the sheet P1. Then, the process proceeds to S14 in order to promote the drying of the discharged ink.

In S14, the sheet P1 is transported to the hot air unit 51 which is the drying section 50 as a medium feeding process and a drying process. Specifically, the control section 70 drives the suction belt mechanism 20 as the transport unit 10 to feed the sheet P1 to the hot air unit 51 in the downstream side in the feeding direction. Then, the process proceeds to S15 in order to determine the position of the tailing end P1b of the sheet P1.

Furthermore, it is assumed that the suction belt mechanism 20 continues transporting the sheet P1 even after the process proceeds to S15 and thereafter.

In S15, it is determined whether the position of the tailing end P1b of the sheet P1 is detected as a position detecting process. Specifically, the control section 70 determines whether the tailing end P1b of the sheet P1 fed by the suction belt mechanism 20 passes the second sheet detecting sensor 33. Then, when the tailing end P1b of the sheet P1 is detected, the process proceeds to S16 in order to determine the current position of the tailing end P1b of the sheet P1. On the other hand, when the tailing end P1b of the sheet P1 is not detected, the sheet P1 continues to be transported until it is detected.

In S16, the measurement of the distance, from the tailing end P1b of the sheet P1 being transported in the feeding direction Y to the branching point 59a on which the branching path 59, where the air-opening valve 59b is provided, branches off from the main line, is started.

Specifically, at first, the control section 70 receives a signal from the second sheet detecting sensor 33 that the tailing end P1b of the sheet P1 has passed. Then, after the signal is received, how much the suction belt mechanism 20 was driven is calculated by the second encoder 34. Accordingly, the moving distance of the sheet can be obtained after the tailing end P1b of the sheet P1 has passed the second sheet detecting sensor 33. Then, it is possible to obtain the distance from the tailing end of the sheet P1 to the branching point 59a by calculating the difference between the distance from the second sheet detecting sensor 33 to the branching point 59a in the feeding direction Y and the moving distance.

Then, the process proceeds to S17 in order to determine whether to switch the opening and closing of the air-opening valve 59b.

In S17, the control section 70 determined whether it is the point in time to open the air-opening valve 59b. Specifically, it is determined whether the tailing end P1b of the sheet P1 reaches the position of the branching point 59a in the feeding direction Y. When it is determined the tailing end P1b of the sheet P1 reaches the position, the process proceeds to S18 in order to reduce the flow amount and flow rate of the air in the vicinity of the third position (S3 (see FIG. 3)). On the other hand, when it is determined that the tailing end P1b of the sheet P1 has not reached the position, the process returns to S16.

In S18, the control section 70 opens the air-opening valve 59b as an air releasing valve opening process. Accordingly, as described above, the flow amount and the flow rate of the hot air can be reduced in the vicinity of the third position (S3 (see FIG. 3)) in the downstream side of the branching point 59a in the feeding direction in the flow passage 61. As a result, there is no problem that the hot air flutters the tailing end P1b of the sheet P1. Then, the process proceeds to S19 in order to determine whether there is a need to maintain the state of the reduced flow amount and flow rate of the hot air.

In S19, it is determined whether the tailing end P1b of the sheet P1 passes through the opening portion 58. To explain in detail, it is determined whether the tailing end P1b of the sheet P1 reaches the position of the downstream end 58a of the opening portion 58 in the feeding direction Y. In other words, it is determined whether the tailing end P1b of the sheet P1 reaches the position where it does not face the opening portion 58. Specifically, it is possible to determine the position of the tailing end P1b of the sheet P1 by the second sheet detecting sensor 33 and the second encoder 34 as described above. In addition, it is determined whether the distance from the second sheet detecting sensor 33 to the tailing end P1b of the sheet P1 is close to the distance from the second sheet detecting sensor 33 to the downstream end 58a of the opening portion 58 in the feeding direction.

When it is determined that the tailing end P1b of the sheet P1 reaches the position, the process proceeds to S20. This is for returning to the initial state of the flow amount and flow rate of the hot air without having to necessarily maintain the state of the reduced flow amount and flow rate of the hot air in the vicinity of the third position (S3 (see FIG. 3)).

On the other hand, when it is determined that the tailing end P1b of the sheet P1 does not reach the position, the process returns to S18. This is for maintaining the reduced flow amount and flow rate of the hot air in the vicinity of the third position.

In S20, the control section 70 closes the air-opening valve 59b as an air releasing valve closing process. Accordingly, it is possible to have the initial state of the flow amount and flow rate of the hot air in the vicinity of the third position (S3 (see FIG. 3)). As a result, it is possible to dry the leading end of the succeeding sheet P2 with efficiency. Then, the sequence is ended.

As described above, it is preferable that the distance L1 from the tailing end P1b of the preceding sheet P1 to the leading end P2a of the succeeding sheet P2 be equal to the distance L2 from the position of the branching point 59a in the feeding direction Y to the downstream end 58a of the opening portion 58 in the feeding direction. This is because there is no problem such that the drying efficiency in leading end side of the succeeding sheet P2 decreases.

As described above, by providing the air-opening valve 59b, it is possible to reduce fluttering of the tailing end P1b of the sheet P1 in the position within the range where the opening portion 58 extends in the feeding direction Y without adjusting the intensity of the blowing fan 55. At the same time, it is possible to maintain the drying efficiency of the leading end side of the succeeding sheet P2. In other words, it is possible to reduce the problem of the tailing end P1b of the preceding sheet P1 fluttering without decreasing the drying efficiency of the leading end side of the succeeding sheet P2.

In the present embodiment, the point in time to open the air-opening valve 59b is set to the point in time when the tailing end of the sheet reaches the branching point in the feeding direction, but it is possible to set a point in time slightly earlier than that. However, when it is too early, it is possible to reduce the problem that the tailing end of the sheet flutters, but there is a problem that the flow amount and flow rate of the hot air to the leading end side of the sheet in the vicinity of the third position (S3 (see FIG. 3)) reduces and drying is not performed completely. Therefore, the point in time to open the air-opening valve 59b may be advanced as long as the drying efficiency in the leading end side of the sheet in the vicinity of the third position (S3 (see FIG. 3)) does not decrease.

The printer 1 as a recording apparatus in the present embodiment includes recording heads 41 which execute recording by discharging ink onto the sheet P which is an example of the recording medium, the transport unit 10 which feeds the sheet P to the downstream side in the feeding direction as the medium feeding unit, the second sheet detecting sensor 33 which detects the position of the sheet P in the feeding direction Y as the position detecting unit 30, the hot air unit 51 including the blowing fan 55 which is provided on the downstream side of the recording heads 41 in the feeding direction as an example of the air generating unit 54 generating air, the air guiding portion 57 which guides the air generated by the blowing fan 55 from the upstream side to the downstream side in the feeding direction and forms the flow passage 61, and the opening portion 58 which extends in the feeding direction Y in the middle of the flow passage 61 of the air guiding portion 57 so as to face the sheet P, the hot air unit 51 which brings the air guided by the air guiding portion 57 into contact with the sheet P via the opening portion 58 so as to dry ink thereon as the drying section 50, the branching path 59 which branches off over the range where the opening portion 58 extends in the feeding direction Y, branches and guides part of the air flowing from the upstream side to the downstream side in the feeding direction in the air guiding portion 57 of the hot air unit 51, the air-opening valve 59b which is provided on the branching path 59 and is opened and closed as an air releasing valve, and the control section 70 which controls the opening and closing of the air-opening valve 59b according to the position of the sheet P.

In the present embodiment, the control section 70 closes the air-opening valve 59b until the tailing end P1b of the sheet P1 reaches the position of the branching point 59a on which the branching path 59 branches from the air guiding portion 57 in the feeding direction Y when the sheet P passes through the hot air unit 51. The control section 70 opens the air-opening valve 59b when the tailing end P1b of the sheet P1 reaches the position of the branching point 59a in the feeding direction Y, and closes the air-opening valve 59b when the tailing end P1b of the sheet P1 reaches the position of the downstream end 58a of the opening portion 58 in the feeding direction Y.

In the present embodiment, the air guiding portion 57 in the hot air unit 51 has sectional areas (S1 to S3) of the flow passage 61 of the air, which gradually decrease as the air advances from the upstream side to the downstream side in the air flowing direction within the range where the opening portion 58 extends in the feeding direction Y.

In the present embodiment, when there are the first position, the second position, and the third position from the upstream side to the downstream side in the direction where the air flows in this order (see FIG. 3), the following relationship is established;

Sectional area S1 of the first position in the flow passage>Sectional area S2 of the second position in the flow passage>Sectional area S3 of the third position in the flow passage.

Furthermore, in the present embodiment, the number of the branching paths 59 is one and the distance L1 between the tailing end P1b of the preceding sheet P1 and the leading end P2a of the succeeding sheet P2 is equal to the distance L2 from the branching point 59a of the branching path 59 in the feeding direction Y to the downstream end 58a of the opening portion 58 in the feeding direction.

The method of controlling the air-opening valve 59b in the hot air unit 51 of the printer 1 according to the present embodiment includes feeding the sheet P to the downstream side in the feeding direction by the transport unit 10 (S12); recording by discharging ink onto the sheet P from the recording heads 41 (S13); detecting the position of the sheet P in the feeding direction Y by the second sheet detection sensor 33 as the position detecting unit 30 (S15); drying the ink on the sheet using the hot air unit 51 by bringing air guided by the air guiding portion 57 into contact with the sheet P via the opening portion 58, the hot air unit 51 including the air generating unit 54 that is provided on the downstream side of the recording heads 41 in the feeding direction and generates air, the air guiding portion 57 that guides the air generated by the air generating unit 54 from the upstream side to the downstream side in the feeding direction and forms the flow passage 61, and the opening portion 58 that extends in the feeding direction Y in the middle of the flow passage 61 of the air guiding portion 57 so as to face the sheet P (S14); opening the air-opening valve 59b provided on the branching path 59 when the tailing end P1b of the sheet P1 in the feeding direction Y reaches the position of the branching point 59a on which the branching path 59, which branches off over the range where the opening portion 58 extends in the feeding direction Y, branches and guides part of the air flowing from the upstream side to the downstream side in the feeding direction in the air guiding portion 57 of the hot air unit 51, branches off from the air guiding portion 57 (S18); and closing the air-opening valve 59b when the tailing end P1b of the sheet P1 reaches the position of the downstream end 58a of the opening portion 58 in the feeding direction Y (S20) after opening the air-opening valve 59b (S18).

### Other embodiment 1

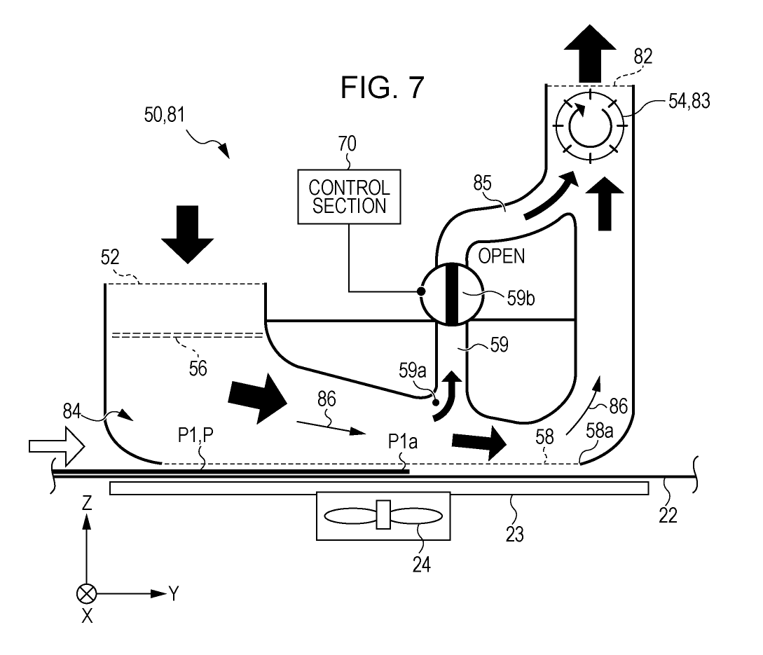

FIG. 7 is a side view schematically showing a hot air unit according to other embodiment 1.

As shown in FIG. 7, the hot air unit 81 according to the other embodiment 1 includes a branching path 85, an air outlet 82, a suction fan 83 as an air generating unit 54.

Since other members have the same configuration as in the embodiment described above, the same reference numerals are given thereto and the explanation thereof will not be repeated.

Among these, the branching path 85 is provided so as to branch off from the main line of a flow passage 86 within the range where the opening portion 58 in the middle of an air guiding portion 84 extends in the feeding direction Y same as the above-described embodiment. In addition, the branching path 85 has an air-opening valve 59b same as the above-described embodiment. One feature that is different from the above-described embodiment is that the downstream side of the air flowing direction in the branching path 85 is connected to an air outlet 82. Different from the blowing fan 55 (FIG. 2 to FIG. 5) of the air inlet 52 in the above-described embodiment, a suction fan 83 is provide in the air outlet 82 in the other embodiment 1.

In this case, the same action and effect can be obtained as in the above-described embodiment by the control section 70 that opens and closes the air-opening valve 59b in accordance with the position of the tailing end P1b of the sheet P1. Specifically, by opening and closing the air-opening valve 59b, the flow amount and flow rate of the air in the vicinity of the third position (S3 (see FIG. 3)) can be reduced. As a result, it is possible to reduce the problem that the hot air flutters the tailing end P1b of the sheet P1.

It is needless to say that the position of the branching point 59a in the feeding direction Y is determined based on the relationship between the force (suction force of a suction unit in a suction belt mechanism, tension and weight of a sheet, and the like) with which the tailing end P1b of the sheet P1 keeps its positioning in the position in the direction of axis Z and the force with which the suction fan 83 separates the tailing end P1b of the sheet P1 from the supporters 22 and 23 supporting the sheet P1, and the shape of the air guiding portion 84.

### Other embodiment 2

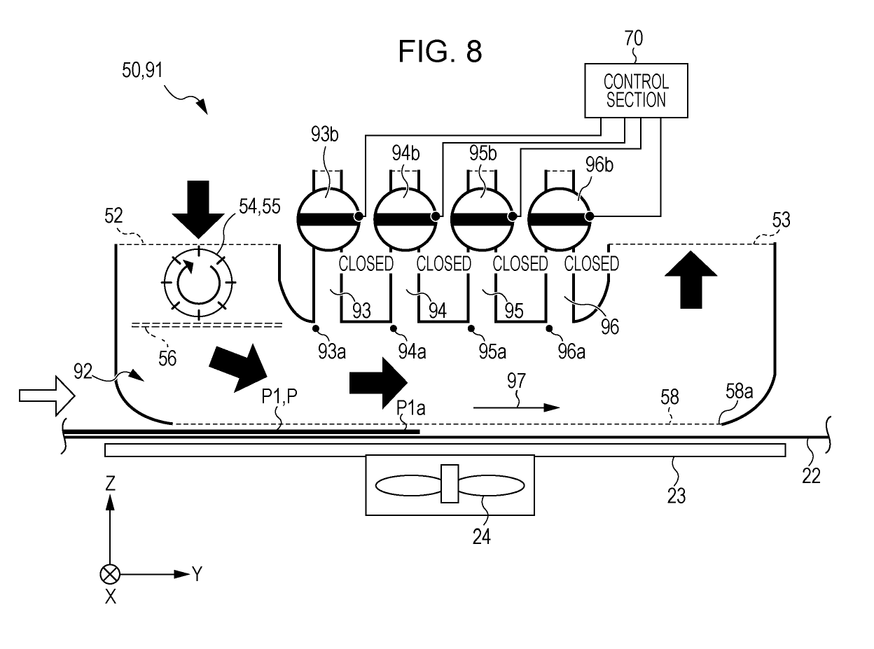

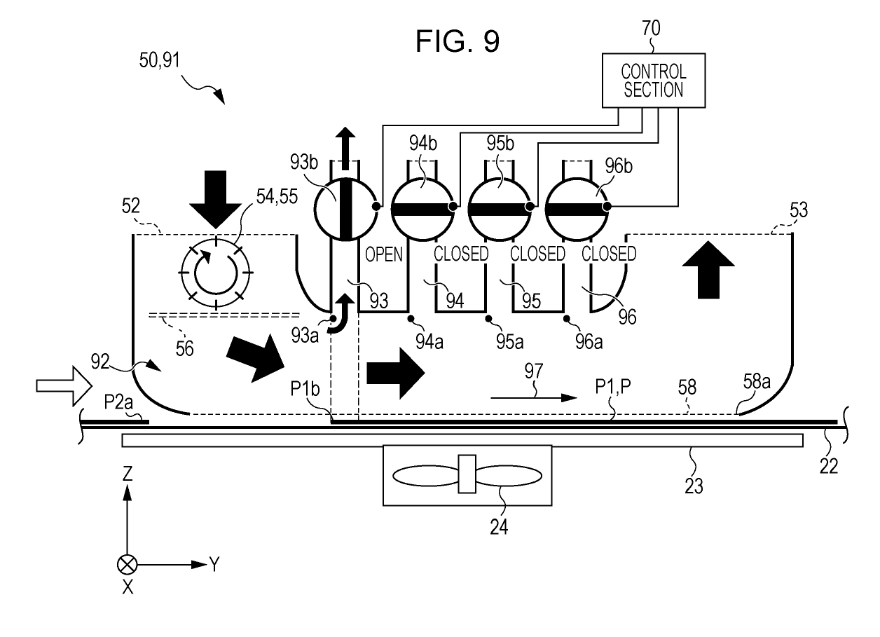

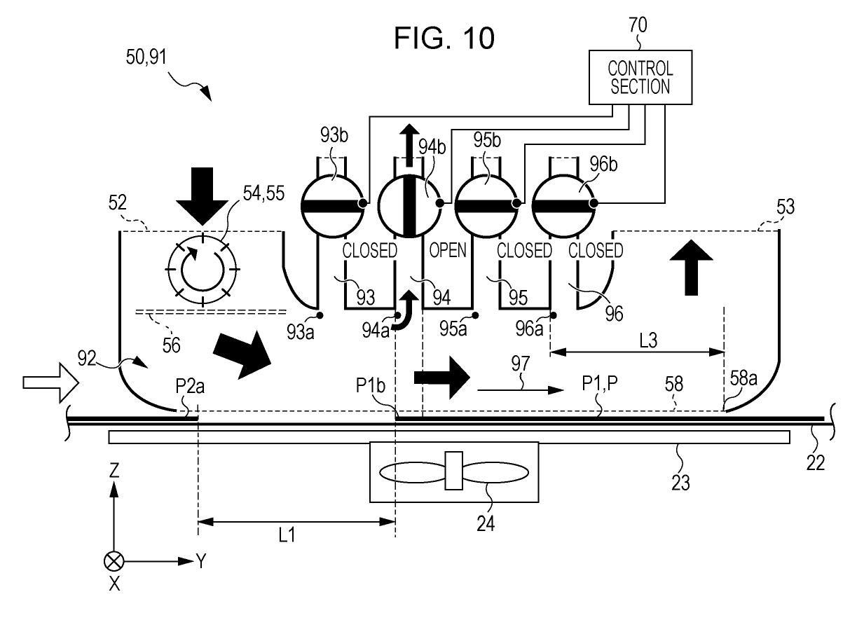

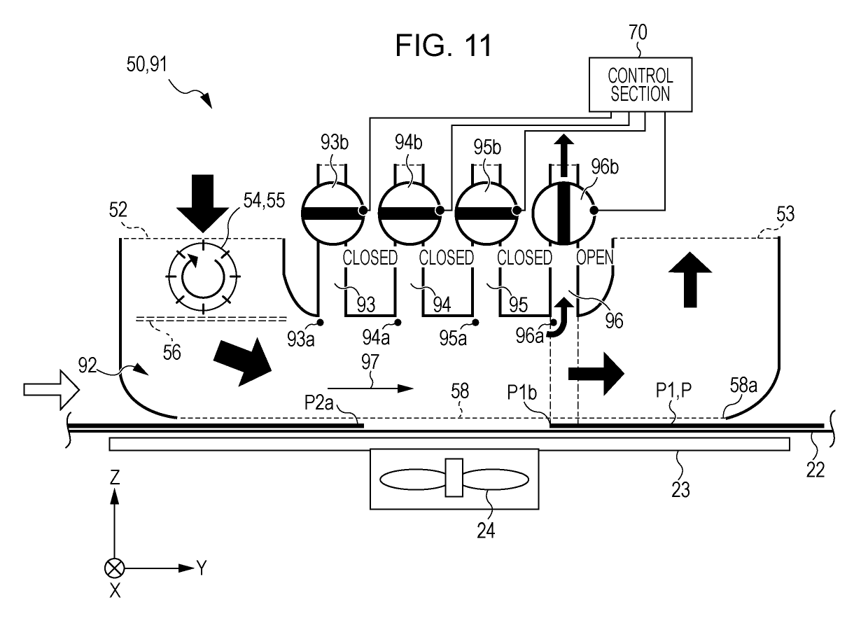

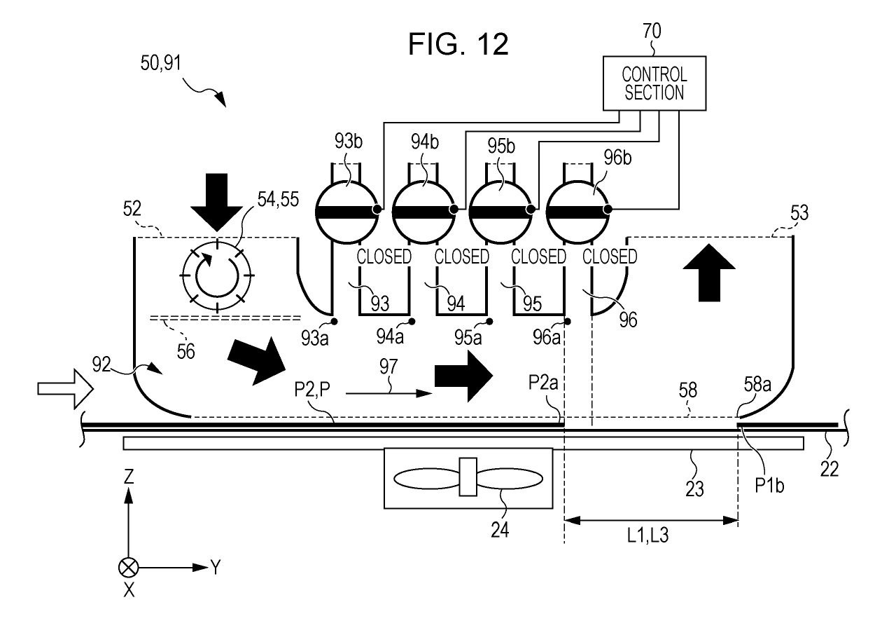

FIG. 8 to FIG. 12 are side views schematically showing the operation of the hot air unit according to other embodiment 2. Among these, FIG. 8 shows a state where the leading end of a sheet is positioned within the range where the opening portion extends in the feeding direction. FIG. 9 shows a state where the tailing end of the sheet reaches the position of a first branching point in the feeding direction. Furthermore, FIG. 10 shows a state where the tailing end of the sheet reaches the position of a second branching point in the feeding direction. FIG. 11 shows a state where the tailing end of the sheet reaches the position of a fourth position in the feeding direction. FIG. 12 shows a state where the tailing end of the sheet reaches the position of the downstream end of the opening portion in the feeding direction.

As shown in FIG. 8 to FIG. 12, the hot air unit 91 according to the other embodiment 2 includes a first branching path 93 to a fourth branching path 96, and a first valve 93b to a fourth valve 96b. Among these, the first branching path 93 to the fourth branching path 96 branch off from the main line of a flow passage 97 within the range where the opening portion 58 in the middle of an air guiding portion 92 extends in the feeding direction Y. Further, the first branching path 93 to the fourth branching path 96 are arranged in series in the order of the first branching path 93, the second branching path 94, the third branching path 95 and the fourth branching path 96 from the upstream side to the downstream side in the feeding direction.

The first valve 93b is provided in the first branching path 93, the second valve 94b in the second branching path 94, the third valve 95b in the third branching path 95, and the fourth valve 96b in the fourth branching path 96. The first valve 93b to the fourth valve 96b are provided so as to be opened and closed by the control section 70.

In addition, as examples of the first valve 93b to the fourth valve 96b, a so-called electromagnetic valve which is a solenoid valve may be used in the same manner as the air-opening valve 59b in the above-described embodiment.

In the other embodiment 2, the point on which the first branching path 93 branches from the main line of the flow passage 97 within the range where the opening portion 58 in the middle of the air guiding portion 92 extends in the feeding direction Y is assumed to be a first branching point 93a. Similarly, the point on which the second branching path 94 branches off from the main line of the flow passage 97 in the air guiding portion 92 is assumed to be a second branching point 94a, the point on which the third branching path 95 branches off from the main line of the flow passage 97 in the air guiding portion 92 is assumed to be a third branching point 95a, and the point on which the fourth branching path 96 branches off from the main line of the flow passage 97 in the air guiding portion 92 is assumed to be a fourth branching point 96a.

Features that are mainly different from the configuration of the above-described embodiment is that there are a plurality of branching paths and valves in the other embodiment 2, and the hot air unit 91 is provided lengthily in the feeding direction Y.

Since other members have the same configuration as in the above-described embodiment, the same reference numerals are given thereto and the explanation thereof will not be repeated.

Next, the operation of the first valve 93b to the fourth valve 96b in the hot air unit 91 according to the other embodiment 2 will be explained.

As shown in FIG. 8, the (preceding) sheet P1 as the first sheet is fed into the hot air unit 91 by the suction belt mechanism 20 after recording was performed in the recording section 40. The leading end side of the preceding sheet P1 advances to the range where the opening portion 58 is provided in the feeding direction Y. At this point, all of the first valve 93b to the fourth valve 96b are in a closed state. Accordingly, it is possible to bring the hot air flowing through the main line into contact with the leading end side of the sheet P1 efficiently via the opening portion 58 and to promote the drying of ink on the sheet without making the hot air branch off from the main line 97.

As shown in FIG. 9, when the suction belt mechanism 20 is driven further from the state of FIG. 8, the preceding sheet P1 is fed further to the downstream side in the feeding direction. When the tailing end P1b of the preceding sheet P1 reaches the position of the first branching point 93a in the feeding direction Y, the control section 70 opens the first valve 93b. Accordingly, it is possible to branch off part of the hot air flowing through the main line to the first branching path 93. Moreover, it is possible to reduce the flow amount and flow rate of the hot air toward the downstream side of the first branching point 93a in the feeding direction Y in comparison with the state where the first valve 93b to the fourth valve 96b are all closed.

As a result, it is possible to reduce the problem that the hot air flutters the tailing end P1b of the preceding sheet P1 when it positioned in the vicinity of the first branching point 93a in the feeding direction Y.

In addition, it is possible to promote the drying of the ink because it is possible to bring a certain amount of the hot air into contact with the tailing end side of the preceding sheet P1 via the opening portion 58.

It is preferable that the distance from the upstream end of the opening portion 58 in the feeding direction to the position of the first branching point 93a in the feeding direction Y be as short as possible. The reason is because it is possible to reduce the problem of the tailing end of the sheet fluttering over that distance.

It is preferable that the upstream end of the opening portion 58 in the feeding direction is provided at the same position as the position of the first branching point 93a in the feeding direction Y when sectional areas in the air guiding portion 92 are same in the upstream side of the first branching point 93a in the air flowing direction.

As shown in FIG. 10, when the suction belt mechanism 20 is driven further from the state of the FIG. 9, the preceding sheet P1 is fed further to the downstream side in the feeding direction. A (succeeding) sheet P2 as a second sheet is fed to the downstream side in the feeding direction and the leading end side of the (succeeding) sheet P2 as the second sheet advances into the range where the opening portion 58 is provided in the feeding direction Y.

The distance L1 from the tailing end P1b of the preceding sheet P1 to the leading end P2a of the succeeding sheet P2 is equal to the distance L3 from the fourth branching point 96a in the feeding direction Y to the downstream end 58a of the opening portion 58 in the feeding direction as description below.

When the tailing end P1b of the preceding sheet P1 reaches the position of the second branching point 94a in the feeding direction Y, the control section 70 opens the second valve 94b and closes the first valve 93b. Accordingly, part of the hot air flowing through the main line can be branched off toward the second branching path 94. Moreover, it is possible to reduce the flow amount and flow rate of the hot air toward the downstream side of the second branching point 94a in the feeding direction Y in comparison with the state where the first valve 93b to the fourth valve 96b are all closed.

As a result, it is possible to reduce the problem that the hot air flutters the tailing end P1b of the preceding sheet P1 when it is positioned in the vicinity of the second branching point 94a in the feeding direction Y.

In addition, it is possible to promote the drying of the ink because it is possible to bring a certain amount of the hot air into contact with the tailing end side of the preceding sheet P1 via the opening portion 58.

Furthermore, it is possible to make the flow amount and flow rate of the hot air in the upstream side of the second branching point 94a in the feeding direction the same as the flow amount and rate in the state where the first valve 93b to the fourth valve 96b are all closed. Accordingly, it is possible to maintain the drying efficiency for the leading end side of the succeeding sheet P2. In other words, there is no problem that the promotion of the drying of the ink on the succeeding sheet P2 in the upstream side of the second branching point 94a in the feeding direction is affected even when the second valve 94b is opened.

Then, when the suction belt mechanism 20 is driven further from the state of FIG. 10, the preceding sheet P1 and the succeeding sheet P2 are fed further to the downstream side in the feeding direction. When the tailing end P1b of the preceding sheet P1 reaches the position of the third branching point 95a in the feeding direction Y, the control section 70 opens the third valve 95b and closes the second valve 94b. Accordingly, it is possible to branch off part of the hot air flowing through the main line toward the third branching path 95. In addition, it is possible to reduce the flow amount and flow rate of the hot air toward the downstream side of the third branching point 95a in the feeding direction Y in comparison with the state where the first valve 93b to the fourth valve 96b are all closed.

As a result, it is possible to reduce the problem that the hot air flutters the tailing end P1b of the preceding sheet P1 when it is positioned in the vicinity of the third branching point 95a in the feeding direction Y in the same manner as when it is positioned in the vicinity of the second branching point 94a described above.

In addition, it is possible to promote the drying of the ink because it is possible to bring a certain amount of the hot air into contact with the tailing end side of the preceding sheet P1 via the opening portion 58.

Furthermore, it is possible to make the flow amount and flow rate of the hot air in the upstream side of the third branching point 95a in the feeding direction the same as the flow amount and rate in the state where the first valve 93b to the fourth valve 96b are all closed. Accordingly, it is possible to maintain the drying efficiency for the leading end side of the succeeding sheet P2. In other words, there is no problem that the promotion of the drying of the ink on the succeeding sheet P2 in the upstream side of the third branching point 95a in the feeding direction is affected even when the third valve 95b is opened.

Then, when the suction belt mechanism 20 is driven further as shown in FIG. 11, the preceding sheet P1 and the succeeding sheet P2 are fed further to the downstream side in the feeding direction. When the tailing end P1b of the preceding sheet P1 reaches the position of the fourth branching point 96a in the feeding direction Y, the control section 70 opens the fourth valve 96b and closes the third valve 95b. Accordingly, it is possible to branch off part of the hot air flowing through the main line toward the fourth branching path 96. In addition, it is possible to reduce the flow amount and flow rate of the hot air toward the downstream side of the fourth branching point 96a in the feeding direction Y in comparison with the state where the first valve 93b to the fourth valve 96b are all closed.

As a result, it is possible to reduce the problem that the hot air flutters the tailing end P1b of the preceding sheet P1 when it is positioned in the vicinity of the fourth branching point 96a in the feeding direction Y in the same manner as when it is positioned in the vicinity of the second branching point 94a described above.

In addition, it is possible to promote the drying of the ink because it is possible to bring a certain amount of the hot air into contact with the tailing end side of the preceding sheet P1 via the opening portion 58.

Furthermore, it is possible to make the flow amount and flow rate of the hot air in the upstream side of the fourth branching point 96a in the feeding direction the same as the flow amount and rate in the state where the first valve 93b to the fourth valve 96b are all closed. Accordingly, it is possible to maintain the drying efficiency for the leading end side of the succeeding sheet P2. In other words, there is no problem that the promotion of the drying of the ink on the succeeding sheet P2 in the upstream side of the fourth branching point 96a in the feeding direction is affected even when the fourth valve 96b is opened.

As shown in FIG. 12, when the suction belt mechanism 20 is driven further from the state of FIG. 11, the preceding sheet P1 and the succeeding sheet P2 are fed further to the downstream side in the feeding direction. When the tailing end P1b of the preceding sheet P1 reaches the position of the downstream end 58a of the opening portion 58 in the feeding direction Y, the control section 70 closes the fourth valve 96b. This is because the tailing end P1b of the preceding sheet P1 is positioned beyond the range where the opening portion 58 extends in the feeding direction Y and there is no problem that the hot air flutters the tailing end P1b of the preceding sheet P1.

On the other hand, the leading end P2a of the succeeding sheet P2 reaches the position of the fourth branching point 96a in the feeding direction Y. This is because, as described above, the distance L1 from the tailing end P1b of the preceding sheet P1 to the leading end of the succeeding sheet is equal to the distance L3 from the fourth branching point 96a in the feeding direction Y to the downstream end 58a of the opening portion 58 in the feeding direction.

After that, when the suction belt mechanism 20 is driven further, the preceding sheet P1 and the succeeding sheet P2 are fed further to the downstream side in the feeding direction.

When the tailing end P2b of the succeeding sheet P2 (as a second sheet) reaches the position of the first branching point 93a in the feeding direction Y, the control section 70 opens the first valve 93b in the same manner as when the tailing end P1b of the preceding sheet P1 reaches the position of the first branching point 93a.

Then, the second valve 94b, the third valve 95b, and the fourth valve 96b are opened in this order and a valve which has been opened adjacent to the upstream side of the feeding direction is closed as the position of the tailing end P2b of the second sheet P2 moves toward the downstream side in the feeding direction in the same manner as when the tailing end P1b of the preceding sheet P1 moves.

As a result, it is possible to reduce the problem that the hot air flutters the tailing end P2b of the succeeding sheet P2 in the same manner as the tailing end P1b of the preceding sheet P1.

Furthermore, there is no problem that the promotion of the drying of the ink for the leading end side of the succeeding sheet P (a third sheet) is affected in the same manner as the leading end side of the second sheet P2.

As described above, by providing valves, it is possible to reduce the fluttering of the tailing end P1b (or P2b) of the sheet P1 (or P2) that is positioned within the range where the opening portion 58 extends in the feeding direction Y without adjusting the intensity of the blowing fan 55. At the same time, it is possible to maintain the drying efficiency for the leading end side of the succeeding sheet P2. In other words, it is possible to reduce the problem of the tailing end P1b of the preceding sheet P1 fluttering without lowering the drying efficiency for the leading end side of the succeeding sheet P2.

The respective number of the branching paths and valves in the other embodiment 2 is assumed to be four, but the number is not limited thereto.

In the other embodiment 2, a plurality of the first branching path 93 to the fourth branching path 96 as a branching path having the first valve 93b to the fourth valve 96b as an air releasing valve are provided, a plurality of the first branching point 93a to the fourth branching point 96a as a branching point on which the first branching path 93 to the fourth branching path 96 branch off from the air guiding portion 92 are arranged in series in the feeding direction Y. With respect to the first valve 93b to the third valve 95b other than the fourth valve 96b corresponding to the fourth branching point 96a, which is the furthest downstream in the feeding direction among the first valve 93b to the fourth valve 96b, the control section 70 opens the valve (for example, the first valve 93b in case of the first branching point 93a) corresponding to the branching point (for example, the first branching point 93a) when the tailing end P1b of the sheet P1 reaches the position of one branching point (for example, the first branching point 93a) in the feeding direction Y. Further, the control section 70 opens the valve (for example, the second valve 94b) corresponding to another branching point (for example, the second branching point 94a) and closes the valve (for example, the first valve 93b) corresponding to the one branching point (for example, the first branching point 93a) when the tailing end P1b of the sheet P1 reaches the position of the another branching point (for example, the second branching point 94a) adjacent to the downstream side of the one branching point (for example, the first branching point 93a) in the feeding direction Y.

Furthermore, with respect to the fourth valve 96b corresponding to the fourth branching point 96a, which is the furthest downstream in the feeding direction among the first valve 93b to the fourth valve 96b, the control section 70 opens the fourth valve 96b corresponding to the fourth branching point 96a, which is the furthest downstream in the feeding direction Y, when the tailing end P1b of the sheet P1 reaches the position of the fourth branching point 96a, which is the furthest downstream in the feeding direction, and the control section 70 closes the fourth valve 96b corresponding to the fourth branching point 96a, which is the furthest downstream in the feeding direction, when the tailing end P1b of the sheet P1 reaches the position of the downstream end 58a of the opening portion 58 in the feeding direction Y.

In the other embodiment 2, the number of the branching paths is plural from the first branching path 93 to the fourth branching path 96, and the distance L1 between the tailing end P1b of the preceding sheet P1 and the leading end P2a of the succeeding sheet P2 is equal to the distance L3 from the fourth branching point 96a, which is the furthest downstream in the feeding direction Y, to the downstream end 58a of the opening portion 58 in the feeding direction.

The method of controlling the first valve 93b to the fourth valve 96b as a plurality of air releasing valves in the hot air unit 91 of the printer 1 according to the other embodiment 2 includes feeding the sheet P to the downstream side in the feeding direction by the transport unit 10 (S12); recording by discharging ink onto the sheet P from the recording heads 41 (S13); detecting the position of the sheet P in the feeding direction Y by the second sheet detecting sensor 33 as the position detecting unit 30 (S15); drying ink on the sheet using the hot air unit 91 by bringing the air guided by the air guiding portion 92 into contact with the sheet P via the opening portion 58, the hot air unit 91 including the air generating unit 54 that is provided on the downstream side of the recording heads 41 in the feeding direction and generates air, the air guiding portion 92 that guides the air generated by the air generating unit 54 from the upstream side to the downstream side in the feeding direction and forms the flow passage 97, and the opening portion 58 that extends in the feeding direction Y in the middle of the flow passage 97 of the air guiding portion 92 so as to face the sheet P (S14); with respect to the first valve 93b to the fourth valve 96b that are arranged in series in this order in the feeding direction Y, branched off over the range where the opening portion 58 which extends in the feeding direction Y, and provided on a plurality of branching paths from the first branching path 93 to the fourth branching path 96 that branches and guides part of the air flowing from the upstream side to the downstream side in the feeding direction in the air guiding portion 92 of the hot air unit 91, opening the valve (for example, the first valve 93b in case of the first branching point 93a) corresponding to one branching point (for example, the first branching point 93a) when the tailing end P1b of the sheet P1 reaches the position of the one branching point (for example, the first branching point 93a) in the feeding direction Y, with respect to the first valve 93b to the third valve 95b other than the fourth valve 96b corresponding to the fourth branching point 96a, which is the furthest downstream in the feeding direction among a plurality of branching points from the first branching point 93a to the fourth branching point 96a, on which the first branching path 93 to the fourth branching path 96 branch off from the air guiding portion 92 among the first valve 93b to the fourth valve 96b, and opening the fourth valve 96b corresponding to the fourth branching point 96a, which is the furthest downstream in the feeding direction, when the tailing end P1b of the sheet P1 reaches the position of the fourth branching point 96a, which is the furthest downstream in the feeding direction Y, with respect to the fourth valve 96b corresponding to the fourth branching point 96a, which is the furthest downstream in the feeding direction among the first valve 93b to the fourth valve 96b (corresponding to S18 in the above-described embodiment); and closing the valve (for example, the second valve 94b) corresponding to one branching point (for example, the first branching point 93a) when the tailing end P1b of the sheet P1 reaches the position of another branching point (for example, the second branching point 94a) adjacent to the downstream side of the one branching point (for example, the first branching point 93a) in the feeding direction Y, with respect to the first valve 93b to the third valve 95b other than the fourth valve 96b corresponding to the fourth branching point 96a, which is the furthest downstream in the feeding direction among the first valve 93b to the fourth valve 96b, and closing the fourth valve 96b corresponding to the fourth branching point 96a, which is the furthest downstream in the feeding direction, when the tailing end P1b of the sheet P1 reaches the position of the downstream end 58a of the opening portion 58 in the feeding direction Y, with respect to the fourth valve 96b corresponding to the fourth branching point 96a, which is the furthest downstream in the feeding direction among the first valve 93b to the fourth valve 96b (corresponding to S20 in the above-described embodiment).

The invention is not limited to the above embodiments, various modifications can be made not imparting from the spirit of the claim of the invention, and those modifications are also included within the scope of the invention.

What is claimed is:

1. A recording apparatus comprising:
recording heads that execute recording by discharging ink onto a recording medium;
a medium feeding unit that feeds the recording medium to a downstream side in a feeding direction;
a position detecting unit that detects the position of the recording medium in the feeding direction;
a drying section including an air generating unit that is provided on the downstream side of the recording heads in the feeding direction and generates air, an air guiding portion that guides the air generated by the air generating unit from the upstream side to the downstream side in the feeding direction and forms a flow passage, and an opening portion which extends in the feeding direction in the middle of the flow passage of the air guiding portion so as to face the recording medium, the drying section bringing the air guided by the air guiding portion into contact with the recording medium via the opening portion so as to dry the ink on the recording medium;
a branching path which branches off over the range where the opening portion extends in the feeding direction, branches and guides part of the air flowing from the upstream side to the downstream side in the feeding direction in the air guiding portion of the drying section;
an air releasing valve which is provided on the branching path and is opened or closed; and
a control section which controls the opening or closing of the air releasing valve according to the position of the recording medium.

2. The recording apparatus according to claim 1,
wherein, in the case where the recording medium passes through the drying section, the control section closes the air releasing valve until the tailing end of the recording medium reaches the position of a branching point on which the branching path branches from the air guiding portion in the feeding direction,
the control section opens the air releasing valve when the tailing end of the recording medium reaches the position of the branching point in the feeding direction, and
the control section closes the air releasing valve when the tailing end of the recording medium reaches the position of the downstream end of the opening portion in the feeding direction.

3. The recording apparatus according to claim 1,
wherein the air guiding portion in the drying section has an air flow passage of which a sectional area gradually decreases as the air advances from the upstream side to the downstream side in the range where the opening portion extends in the feeding direction.

4. The recording apparatus according to claim 1,
wherein a plurality of the branching paths having the air releasing valve is provided;
wherein a plurality of the branching points is arranged in series in the feeding direction, on which the branching paths branch off from the air guiding portion;
wherein, with respect to the air releasing valves other than the air releasing valve corresponding to the furthest downstream branching point in the feeding direction among the plurality of the air releasing valves, when the tailing end of the recording medium reaches the position of one branching point in the feeding direction, the control section opens the air releasing valve corresponding to the one branching point, and when the tailing end of the recording medium reaches the position of another branching point adjacent to the downstream side of the one branching point in the feeding direction, the control section opens the air releasing valve corresponding to the another branching point and closes the air releasing valve corresponding to the one branching point; and
wherein, with respect to the air releasing valve corresponding to the furthest downstream branching point in the feeding direction among the plurality of the air releasing valves, when the tailing end of the recording medium reaches the position of the furthest downstream branching point the feeding direction, the control section opens the air releasing valve corresponding to the furthest downstream branching point in the feeding direction, and when the tailing end of the recording medium reaches the position of the downstream end of the opening porting in the feeding direction, the control section closes the air releasing valve corresponding to the furthest downstream branching point in the feeding direction.

5. The recording apparatus according to claim 1,
wherein, when the number of the branching paths is one, the distance between the tailing end of the preceding recording medium and the leading end of the succeeding recording medium is equal to the distance from the branching point of the branching path in the feeding direction to the downstream end of the opening portion in the feeding direction; and
wherein, when the number of the branching paths is more than one, the distance between the tailing end of the preceding recording medium and the leading end of the succeeding recording medium is equal to the distance from the furthest downstream branching point in the feeding direction to the downstream end of the opening portion in the feeding direction.

6. A method of controlling an air releasing valve in a drying section of a recording apparatus, comprising:
feeding a recording medium to a downstream side in a feeding direction by a medium feeding unit;
recording by discharging ink onto the recording medium from recording heads;
detecting a position of the recording medium in the feeding direction by a position detecting unit;
drying ink on the recording medium using a drying section by bringing the air guided by the air guiding portion into contact with the recording medium via an opening portion, the drying section including an air generating unit that is provided on the downstream side of the recording heads in the feeding direction and generates air, an air guiding portion that guides the air generated by the air generating unit from the upstream side to the downstream side in the feeding direction and forms a flow passage, and an opening portion that extends in the feeding direction in the middle of the flow passage of the air guiding portion so as to face the recording medium;
opening an air releasing valve provided on a branching path when the tailing end of a recording medium in the feeding direction reaches a position of a branching point where the branching path, which branches off over the range where the opening portion extends in the feeding direction, branches and guides part of the air flowing from the upstream side to the downstream side in the feeding direction in the air guiding portion of the drying section, branches off from the air guiding portion; and
closing the air releasing valve when the tailing end of the recording medium reaches the position of the downstream end of the opening portion in the feeding direction after the opening of the air releasing valve.

7. A method of controlling a plurality of air releasing valves in a drying section of a recording apparatus, comprising:
feeding a recording medium to a downstream side in a feeding direction by a medium feeding unit;
recording by discharging ink onto the recording medium from recording heads;
detecting a position of the recording medium in the feeding direction by a position detecting unit;
drying ink on the recording medium using a drying section by bringing the air guided by the air guiding portion into contact with the recording medium via an opening portion, the drying section including an air generating unit that is provided on the downstream side of the recording heads in the feeding direction and generates air, an air guiding portion that guides the air generated by the air generating unit from the upstream side to the downstream side in the feeding direction and forms a flow passage, and an opening portion that extends in the feeding direction in the middle of the flow passage of the air guiding portion so as to face the recording medium;
with respect to a plurality of air releasing valves that are arranged in series in this order in the feeding direction, branched off over the range where the opening portion extends in the feeding direction and provided on a plurality of branching paths that branches and guides part of the air flowing from the upstream side to the downstream side in the feeding direction in the air guiding portion of the drying section,
opening an air releasing valve corresponding to one branching point when the tailing end of the recording medium reaches the position of the one branching point in the feeding direction, with respect to the air releasing valves other than the air releasing valve corresponding to the furthest downstream branching point in the feeding direction among a plurality of branching points on which the plurality of the branching paths branches off from the air guiding portion among the plurality of the air releasing valves, and opening the air releasing valve corresponding to the furthest downstream branching point in the feeding direction when the tailing end of the recording medium reaches the position of the furthest downstream branching point in the feeding direction, with respect to the air releasing valve corresponding to the furthest downstream branching point in the feeding direction among the plurality of the air releasing valves; and
closing an air releasing valve corresponding to one branching point when the tailing end of the recording medium reaches a position of another branching point adjacent to the downstream side of the one branching point in the feeding direction, with respect to the air releasing valves other than the air releasing valve corresponding to the furthest downstream branching point in the feeding direction among the plurality of the air releasing valves, and closing the air releasing valve corresponding to the furthest downstream branching point in the feeding direction when the tailing end of the recording medium reaches the position of the downstream end of the opening portion in the feeding direction, with respect to the air releasing valve corresponding to the furthest downstream branching point in the feeding direction among the plurality of the air releasing valves.
